(19) United States
(12) Patent Application Publication
(10) Pub. No.: US 2015/0157033 A1
(43) Pub. Date: Jun. 11, 2015

(54) Seafood Processing Apparatus and Methods of Processing Seafood

(71) Applicant: P.T. TOBA SURIMI INDUSTRIES, MEDAN (ID)

(72) Inventors: Gindra Tardy, Medan (ID); Irsan Sudargo, Medan (ID)

(73) Assignee: P.T. TOBA SURIMI INDUSTRIES, MEDAN (ID)

(21) Appl. No.: 14/101,898

(22) Filed: Dec. 10, 2013

(51) Int. Cl. A23B 4/005

(52) U.S. Cl. CPC A23B 4/0056

(57) ABSTRACT

A method of processing seafood includes putting a sealed package 114 containing seafood into a seafood processing chamber 112, submerging the package in a liquid 118, heating liquid to a pasteurization temperature to pasteurize the seafood and providing a controlled pressure gas 124 in the processing chamber. The controlled pressure P1 is controlled such that during pasteurization of the seafood an internal pressure P2 in the package is at least one of: not greater than the pressure P1 by a predetermined amount; equal to the pressure P1; and less than said pressure P1.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### CROSS-REFERENCES TO RELATED APPLICATIONS

This application claims benefit of the following patent application(s) which is/are hereby incorporated by reference: None

### STATEMENT REGARDING FEDERALLY SPONSORED RESEARCH OR DEVELOPMENT

Not Applicable

### REFERENCE TO SEQUENCE LISTING OR COMPUTER PROGRAM LISTING APPENDIX

Not Applicable

### BACKGROUND OF THE INVENTION

The present invention relates to a seafood processing apparatus and methods of processing seafood.

It is known to process packaged seafood by pasteurization or sterilization. Pasteurization usually involves heating the packaged seafood to temperatures of around 85 to 90° C. and then cooling prior to storing the packages in refrigerated conditions. Sterilization usually involves heating the seafood to temperatures of around 115 to 121° C. Sterilized seafood does not need to be stored in refrigerated conditions.

In known pasteurization apparatus and methods, seafood is packaged in sealed packages. The packages may be metal cans, plastics tubs that have an aluminium easy open lid or plastics pouches. The packaged seafood is loaded into baskets and placed in an unpressurised cooking tank. The baskets are submerged in water in the cooking tank. The water is heated to bring it up to the cooking temperature. The cooking temperature is typically 85 to 90° C. Once the cooking process is complete, the baskets are removed from the cooking tank and submerged in cooling water in an unpressurised cooling tank. Once the cooling process is complete, the pasteurized seafood packages are removed from the pasteurization apparatus and stored in refrigerated conditions.

### BRIEF SUMMARY OF THE INVENTION

The invention provides a method of pasteurizing seafood comprising disposing a sealed package containing seafood in a seafood processing chamber; providing a liquid in said processing chamber in which liquid said package is submerged; heating said liquid to a pasteurization temperature to pasteurize said seafood; providing a controlled pressure gas in said processing chamber; and controlling the pressure P1 of said controlled pressure gas such that during pasteurization of the seafood an internal pressure P2 in said package is at least one of: not greater than said pressure P1 by more than a predetermined amount; equal to said pressure P1; and less than said pressure P1.

The invention also includes seafood processing apparatus comprising: a seafood processing chamber to receive a liquid in which sealed packages containing seafood are to be submerged; a heating system to deliver heat to said liquid in said processing chamber to heat said liquid to a pasteurization temperature to pasteurize the seafood in said sealed packages; a gas supply system to supply pressurized gas to said processing chamber; and a control system configured to control the pressure P1 of the pressurized gas in said processing chamber such that during pasteurization of the seafood an internal pressure P2 in said seafood package is at least one of: not greater than said pressure P1 by more than a predetermined amount; equal to said pressure P1; and less than said pressure P1.

### BRIEF DESCRIPTION OF THE SEVERAL VIEWS OF THE DRAWINGS

FIG. 1 is an exploded schematic side elevation view of a sealed package containing seafood;

FIG. 2 is a schematic sectional view of the package of FIG. 1;

FIG. 3 is an enlargement of a portion of FIG. 2 showing an annular member of the package;

FIG. 4 is a partial section view of a closure member of the packaged crabmeat product illustrating a laminate structure of a closure member of the package;

FIG. 5 is a schematic representation of a seafood processing apparatus;

FIG. 6 is a perspective view of an example of a seafood processing apparatus according to FIG. 5;

FIG. 7 is a plan view of the seafood processing apparatus of FIG. 6;

FIG. 8 is a side elevation of the seafood processing apparatus of FIG. 6;

FIG. 9 is a side elevation of a processing chamber of the seafood processing apparatus of FIG. 6 with side panels removed to show the interior of the chamber;

FIG. 10 is a perspective view of a package container of the seafood processing apparatus of FIG. 6;

FIG. 11 is a perspective view of a separation member for use in the package container of FIG. 10;

FIG. 12 is a perspective view of another separation member for use in the package container of FIG. 10; and

FIG. 13 is a schematic representation of a controller of the seafood processing apparatus of FIG. 5.

### DETAILED DESCRIPTION OF THE INVENTION

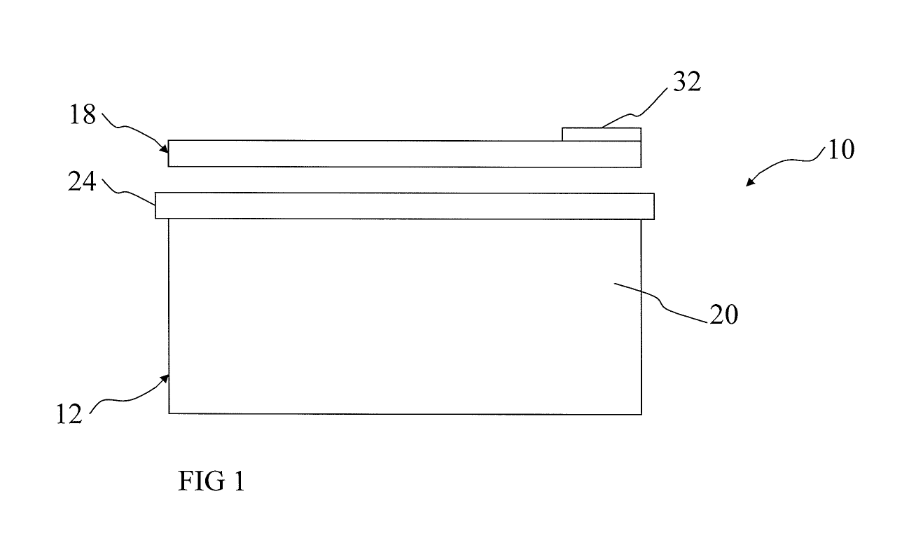

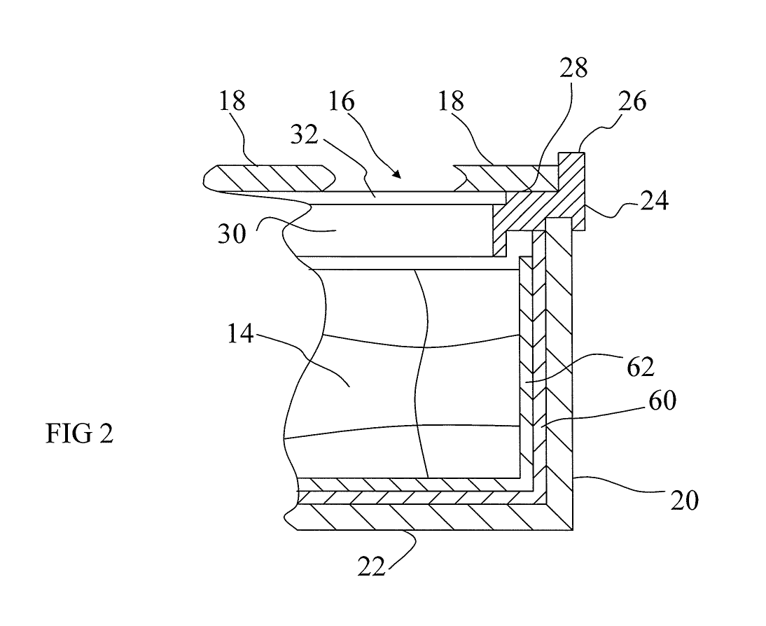

Referring to FIGS. 1 to 4, a sealed package 10 containing seafood comprises a metal body 12 containing pasteurized crabmeat 14. The metal body 12 may have an opening 16 to permit access to the crabmeat. The package 10 further comprises a closure member 18 releasably sealingly closing the opening 16. The closure member 18 comprises at least a portion that is configured to permit viewing of the crabmeat 14 through the closure member. It should be understood that it is not essential that the seafood is crabmeat and that the package may contain other types of seafood. However, for convenience, in the description of the package 10 that follows, reference will be made to the package containing crabmeat 14.

The metal body 12 comprises a cylindrical side wall 20 closed at one end by a transverse bottom wall 22. Although not essential, in the illustrated example the side wall 20 and bottom wall 22 are integral and may be formed by a metal pressing process, such as drawing. Alternatively, the side wall 20 and bottom wall 22 may be separate and joined by seaming. The metal body 12 may be formed from a suitable plated steel, such as tin plated steel. In another example, the metal body may be formed of tin free steel, which may be produced by applying an electrolytic chromic acid treatment of sheet steel.

The opening 16 is defined in the region of the free end of the side wall 20 by an annular member 24 that is secured to the side wall. The annular member 24 may be secured to the metal body 12 by a crimping or rolling process, or by means of a suitable soldering or adhering process. The annular member 24 may be a metal member and is preferably made of a metal having the same, or a similar, coefficient of thermal expansion as the metal from which the metal body 12 is made.

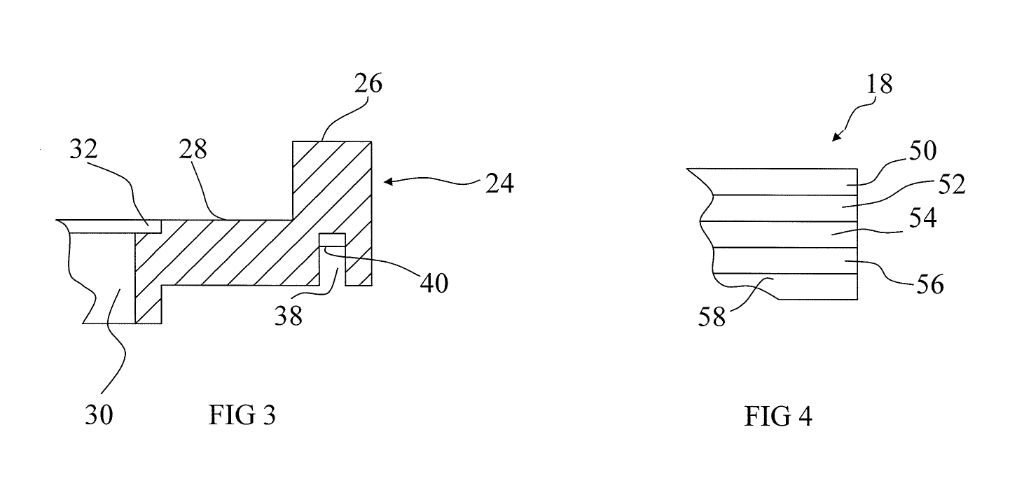

The annular member 24 comprises an upstanding outer side wall 26, an annular ledge 28 extending radially inwardly of the side wall 26 and a downwardly extending annular lip 30 at the radially inner edge of the ledge. The lip 30 defines the opening 16. The ledge 28 is disposed below the free, or upper, end of the outer side wall 26 so that the annular member 24 defines a recess to receive the closure member 18. An annular recess 32 may be provided in the upper face of the ledge 28 where it meets the lip 30 so as to ensure that there are no upward bulges, or discontinuities, at the inner periphery of the ledge that might interfere with sealing between the ledge and the closure member 18. An annular groove 38 (FIG. 3) is provided in the underside of the annular member 24 to receive the free end of the side wall 20 so that the annular member can seat on the side wall. In examples in which the annular member 24 is secured to the metal body 12 by crimping or rolling, a sealing material 40 may be provided in the groove 38. The sealing material 40 may be a deformable material and in the illustrated example comprises a resilient layer, for example made of rubber, pre-bonded to the annular member 24.

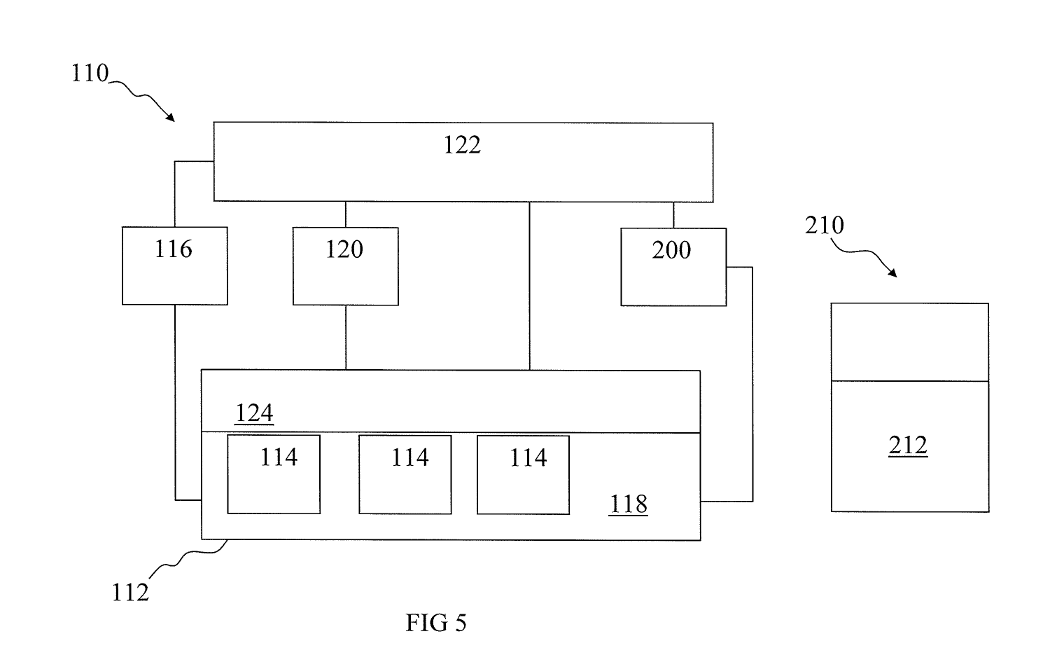

The closure member 18 is a plastics member with a circular profile configured to allow the closure member to seat on the ledge 28 with its outer periphery disposed radially inwardly of and adjacent the outer side wall 26 of the annular member 24. The upper side of the closure member 18 may be provided with a pull tab 32 (FIG. 4) or other means by which a consumer can apply a force to the closure member to pull the closure member away from the ledge 28. The configuration of the closure member 18 and of the recess defined by the outer side wall 26 and ledge 28 of the annular member 24 is preferably such that when the closure member is seated on the ledge, its upper surface is below the free end of the outer side wall 26 so that the closure member is completely received in the recess to provide protection for the closure member during transportation, handling and storage.

Although not essential, in the illustrated example, the closure member 18 is a plastics laminate. As best seen in FIG. 4, the laminate structure may comprise:

a layer 50 of polyethylene terephthalate (PET)

a printed layer 52

a layer 54 of PET SiOx

a layer 56 of PET

a polymer peel layer 58.

The layer thicknesses may be:
layer 50—23 microns
layer 54—12 microns
layer 56—12 microns
layer 58—50 microns
This overall thickness of the closure member 18 may be 0.109 mm plus or minus 10%.

In the illustrated example, the closure member 18 is substantially transparent across its entire major surface area, thereby making it easy to view the crabmeat 14. The only obstruction to sight of the crabmeat will be the printing of the printed layer 52. In general, it is likely to be preferable to minimize the amount of printing on the closure member 18 as this is likely to reduce the viewing area unnecessarily. In some examples, the printed layer 52 may comprise a solid band of color printed around the periphery of the closure member 18, thereby defining a centrally located viewing portion, or window.

In the example illustrated by FIG. 4, the closure member 18 releasably sealingly closes the opening 16 by adhesion between the peel layer 58 and the ledge 28. The material forming the peel layer 58 is one suitable for use in packaging foodstuffs and is selected to provide sufficient adhesion to maintain a seal during transport, handling and storage, yet allow removal by pulling on the tab 32 to peel the closure member 18 away from the ledge 28 so as to provide access to the crabmeat 14. The peel layer 58 may be a polyethylene or polypropylene peel layer. The peel layer 58 may extend across the entire major surface of the underside of the closure member 18 or be applied as an annular layer to an area of the closure member that will seat on the ledge 28.

In other examples, the peel layer 58 may be omitted and a suitable adhesive or bonding material provided on at least one of the outer periphery of the underside of the closure member 18 and the ledge 28. The adhesive or bonding material would be one suitable for use in packaging foodstuffs and selected to provide sufficient adhesion to maintain a seal during transport, handling and storage, yet allow removal by pulling on the tab 32 to peel the closure member 18 away from the ledge 28 so as to provide access to the crabmeat 14.

In the illustrated example, the closure member 18 is a laminate comprising five layers. It is to be understood that this is not essential as one or more layers may be omitted or added. For example, one or both of a transparent ultra violet (UV) blocking and a vapor blocking layer may be included in the laminate structure. Normal plastics materials will leak vapors over time so it may be desirable to include one or more vapor blocking layers to reduce such leakage and potentially extend the shelf life of the packaged crabmeat product. The vapor blocking layer may comprise a transparent aluminum oxide. The silicon oxide component of the PET SiOx layer 54 of the example illustrated in FIG. 4 may function as a vapor barrier. A laminate closure member such as that shown in FIG. 4 with an added UV and vapor blocking layer may have a thickness in the range 0.109 to 0.218 mm plus or minus 10%. It is presently anticipated that laminate structures with a thickness up to about 0.3 mm may be utilized and so in some examples, the closure member may have a thickness in the range of about 0.1 to 0.3 mm plus or minus 10%.

The inner walls of the metal body 12 may be coated with a suitable protective coating 60. The protective coating 60 may assist in isolating the crabmeat 14 from the metal body 12. The protective coating 60 may also provide a layer of protection in the event the plating is damaged or defective so that the crabmeat 14 will not be affected by any corrosion of the metal body 12 that might otherwise occur. The coating 60 may be a lacquer suitable for use in packaging foodstuffs, for example, polyethylene terephthalate.

A lining 62 may be provided between the metal body 12 and crabmeat 14. The lining 62 may cover the inner sides of the cylindrical side wall 20 and the bottom wall 22 and be provided as a one piece lining. The lining 62 may help to prevent metal from the metal body 12 leaching, or migrating, into the crabmeat 14 and adversely affecting its flavor. In the illustrated example, the lining 62 comprises a layer of parchment.

A vegetable oil such as olive or sunflower oil may be added to the crabmeat. The vegetable oil may be added after the crabmeat has been placed in the metal body 12. The vegetable oil, especially olive oil, may improve the flavor of the crabmeat 14. The vegetable oil may also assist in providing a barrier to metal leaching, or migrating, from the metal body 12 into the crabmeat.

Although not essential, the crabmeat 14 typically comprises chunks and similarly large portions of meat, rather than flakes or shredded crabmeat. Although not limited to this use, the metal body 12 and closure member 18 are particularly suitable for packaging premium crabmeat products such as colossal or jumbo chunks. This is because the metal body 12 provides the chunks with protection against damage during handling and storage of the packaged crabmeat product, while the crabmeat 14 can readily be inspected through the closure member 18 to allow a consumer to confirm the presence of undamaged chunks of crabmeat, rather than cheaper, less desirable, flakes and shredded crabmeat. However, it is to be understood that the crabmeat 14 may include any grade of crabmeat, including flakes and shredded crabmeat.

The sealed package 10 may be provided with a paper label (not shown) wrapped around the metal body 12 and carrying details of the supplier and product contained in the package. Alternatively, the package 10 may be provided with a shrink wrap film wrapper (not shown) that may wrap around the metal body 12 and at least partially cover the closure member 18. The shrink film wrapper may be a PET shrink film wrapper. The shrink film wrapper may be printed with details of the supplier and product contained in the package. The engagement of the shrink film wrapper with the metal body 12 and closure member 18 may provide securing of the closure member to the metal body. When a shrink film wrapper is used, it is preferable to avoid printing on parts that will rest against the closure member so as not to reduce the viewing area unnecessarily.

Referring to FIG. 5, a seafood processing apparatus 110 comprises a seafood processing chamber 112 to receive sealed packages 114 containing seafood. The sealed packages 114 may be sealed packages containing crabmeat as illustrated in FIGS. 1 to 4. A heating system 116 is provided to heat a liquid 118 in the processing chamber 112 to a pasteurization temperature to pasteurize the seafood in the packages 114. A gas supply system 120 is provided to supply pressurized gas to the processing chamber 112. A control system 122 is provided to control the pressure P1 of the pressurized gas 124 in the processing chamber 112 such that during pasteurization of the seafood, an internal pressure P2 in the packages 114 is at least one of:

not greater than the pressure P1 by a predetermined amount;

equal to the pressure P1; and

less than said pressure P1.

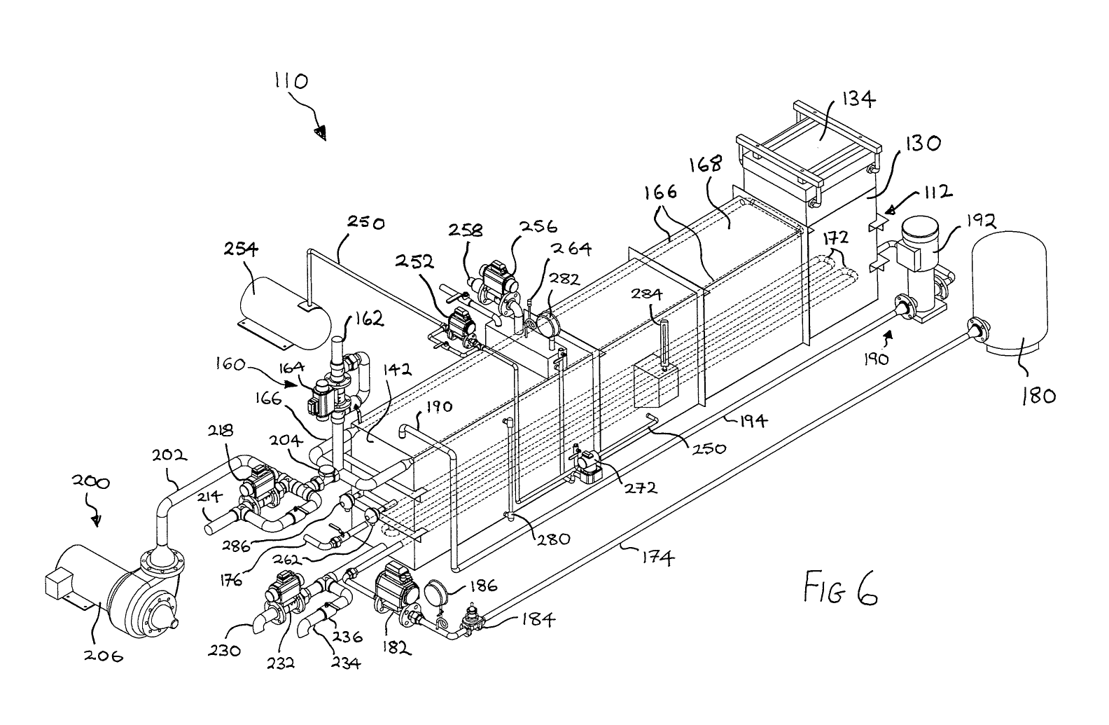

Referring to FIGS. 6 to 8, although not essential, in the illustrated example the processing chamber 112 comprises an elongate tank 130. The tank 130 may have a generally rectangular cross-section. The tank 130 may be fabricated from 3 mm stainless steel plate. An access opening 132 (FIG. 9) is provided to allow loading and unloading of the sealed packages 114. A cover 134 is provided to sealingly close the access opening 132 when the seafood processing apparatus 110 is in use. This allows controlled pressurization of the interior of the processing chamber 112. The cover 134 may be connected to the tank 130 by hinges or the like, or completely removable.

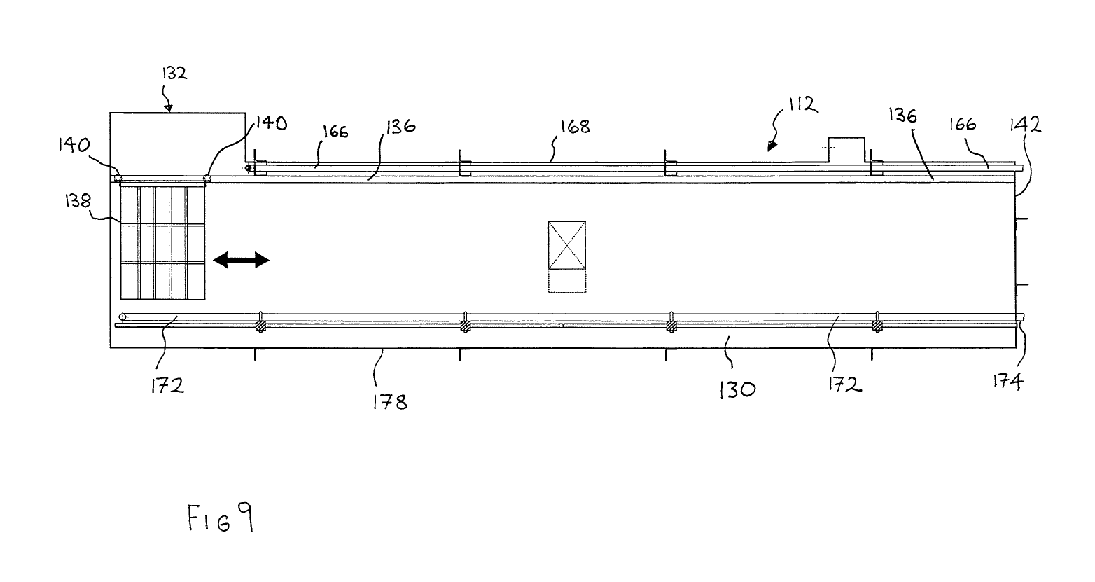

Referring to FIGS. 9 and 10, the processing chamber 112 is provided with an elongate container support 136 and at least one package container 138 that can hold a plurality of the sealed packages 114. The container support may comprise a pair of rails 136 (only one of which is visible in the drawing) disposed in the tank 130. The rails 136 may be disposed towards the top of the tank 130 and extend in the lengthways direction of the tank. In the illustrated example the rails 136 run from one end of the tank to the other and are disposed in opposed parallel spaced apart relation to define a guide track for the package containers 138. The rails 136 may be made of a metal, for example, stainless steel. The rails 136 may be one-piece members or comprise a plurality of members joined end to end.

As shown in FIG. 10, the package containers may comprise baskets 138. The baskets 138 may have a generally rectangular configuration and be open at one end to allow the loading and unloading of sealed packages 114. The baskets 138 may be provided with pairs of rolling members, which may comprise wheels, rollers or the like 140. The wheels 140 may be disposed adjacent the open upper end of the baskets 138 and configured such that a basket can be lowered into the tank 130 through the access opening 132 to seat the wheels 140 on the rails 136. When the wheels 140 are seated on the rails 136, the baskets 138 are suspended from and supported by the rails. Once a basket is seated on the rails 136 under the access opening 132, it may be moved along the rails 136 away from the access opening to allow the loading of further baskets by pushing it to the right (as viewed in FIG. 9). Successive baskets can be used to apply a pushing force to the immediately preceding basket to push them along the tank 130 away from the access opening 132 towards the opposite end 142 of the tank. The baskets 138 may be coupled together, for example by chains (not shown), to permit them to be pulled back towards the access opening 132 when it is desired to unload them.

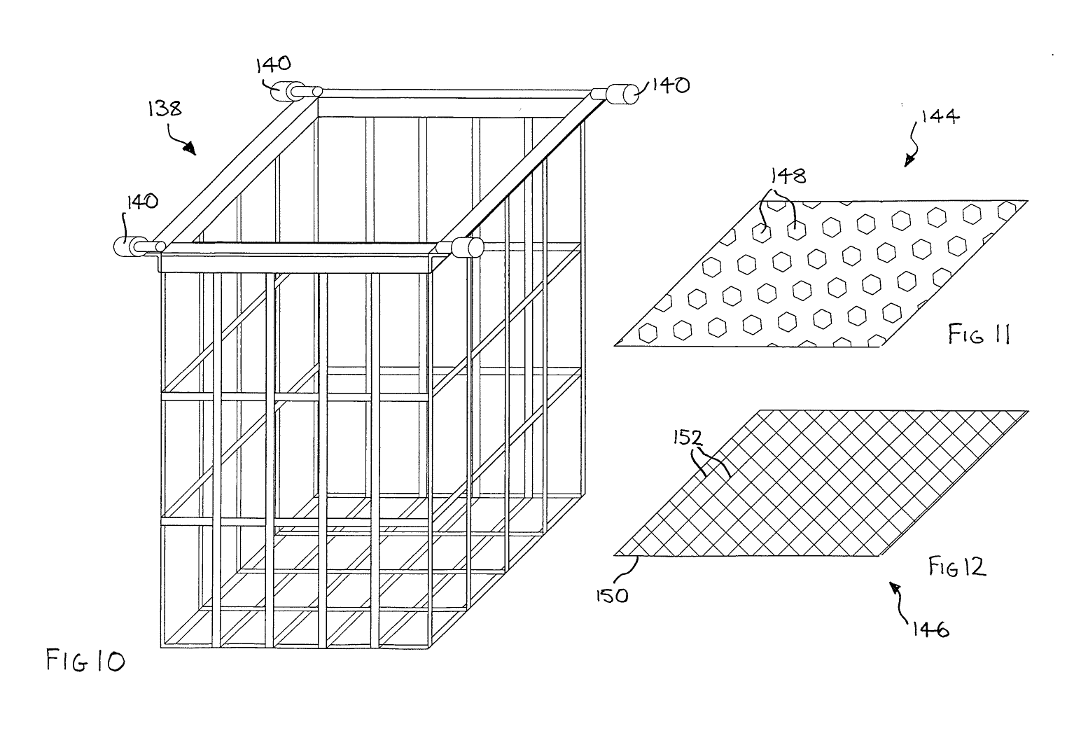

The sealed packages 114 may be stacked one upon another in the baskets 138. Alternatively a layer of packages 114 may be placed in a basket 138 and covered by a separation member such as the separation members 144, 146 illustrated in FIGS. 11 and 12. Another layer of packages 114 can placed on the separation member 144, 146, followed by another separation member and further layers of packages and separation members until such time as the basket 138 is full, or at least, a desired number of packages has been placed in the basket.

The separation member 144 comprises a sheet of metal, or suitably heat resistant plastics material, provided with through-holes 148 to allow for circulation of the liquid 118 during the pasteurization of the seafood in the packages 114. The separation member 146 comprises a frame 150 with a plurality of wires 152 attached to the frame and arranged to form a grid or mesh. The frame 150 and wires 152 may be made of stainless steel.

The separation members 144, 146 may seat directly on the sealed packages 114. Alternatively, separation member supports (not shown) may be secured to the sides of the basket, or spacers disposed between adjacent separation members so that the separation members do not contact the sealed packages 114 below them.

Referring to FIGS. 6 to 8, the seafood processing apparatus 110 may comprise a liquid supply system 160 to fill the tank 130 with the liquid 118 that is heated to pasteurize, or cook, the seafood in the sealed packages 114. The liquid 118 may be water and for convenience in the detailed description that follows, reference will be made to water supply. However, this is not to be taken as limiting.

The liquid supply system 160 may comprises a water inlet pipe 162 that may be directly connected to a source of mains pressure water, or to a header tank. The liquid supply system 160 may further comprise a water inlet valve 164 to permit control of the supply of water to the water tank 130. The water inlet valve 164 may be an electrically controlled valve, such as a solenoid valve. The water inlet pipe 162 joins and forms a T with water distribution piping 166. The water distribution piping 166 comprises left and right branches that enter the tank 130 at the end 142 and extend in parallel spaced apart relation along the tank to the access opening 132, where they are connected by a transverse section so that in plan the water distribution piping has a generally rectangular profile. Water distribution holes (not shown in the drawings) are provided in the water distribution piping 166 so that when the water inlet valve 164 is opened and water flows through the piping, it sprays out from the water distribution piping into the tank 130. Although not essential, the water distribution holes may be evenly distributed along the length of the portion of the water distribution piping 166 that is within the tank 130. Although not essential, in the illustrated example the water distribution piping 166 is disposed adjacent the top of the tank 130 and as shown in FIG. 9 may be suspended from a top panel, or panels, 168 of the tank.

Referring to FIGS. 6 and 9, the heating system 116 may comprise one or more bodies 172 disposed in the processing chamber 112 and having at least one steam outlet through which steam is delivered into the processing chamber. In the illustrated example, there is one such body in the form of steam distribution piping 172. An upstream, or inlet, end of the steam distribution piping 172 is connected with steam supply piping 174 at the end 142 of the tank 130. The steam distribution piping 172 may extend back and forth in the lengthways direction of the tank to define a plurality of convolutions. The downstream end of the steam distribution piping 172 is connected with steam exhaust piping 176, also at the end 142 of the tank 130. The steam distribution piping 172, steam supply piping 174 and steam exhaust piping 176 may comprise 1 inch (25 mm) diameter stainless steel steam piping. In other examples, a plurality of bodies comprising discrete steam distribution pipes may extend into the tank 130 to supply steam into the tank. The steam distribution piping 172 may be disposed adjacent the bottom 178 (FIG. 9) of the tank 130. The heating system 116 may further comprise a steam supply 180. The steam supply 180 may comprise a boiler and a reservoir, or header tank. Alternatively, the steam distribution piping 172 may be connected with a steam supply that is a part of a central services installation supplying steam to various locations in a factory or the like. A steam inlet valve 182 may be provided in the steam supply piping 174 upstream of the tank 130 to control the flow of steam into the tank. The steam inlet valve 182 may be an electrically controlled valve, such as a solenoid valve. Optionally, a pressure regulating valve 184 may be provided in the steam supply piping 174 to permit the inlet pressure of the steam to be controlled. A pressure gauge 186 may be provided to allow an operator to see the inlet pressure of the steam supplied to the processing chamber 112.

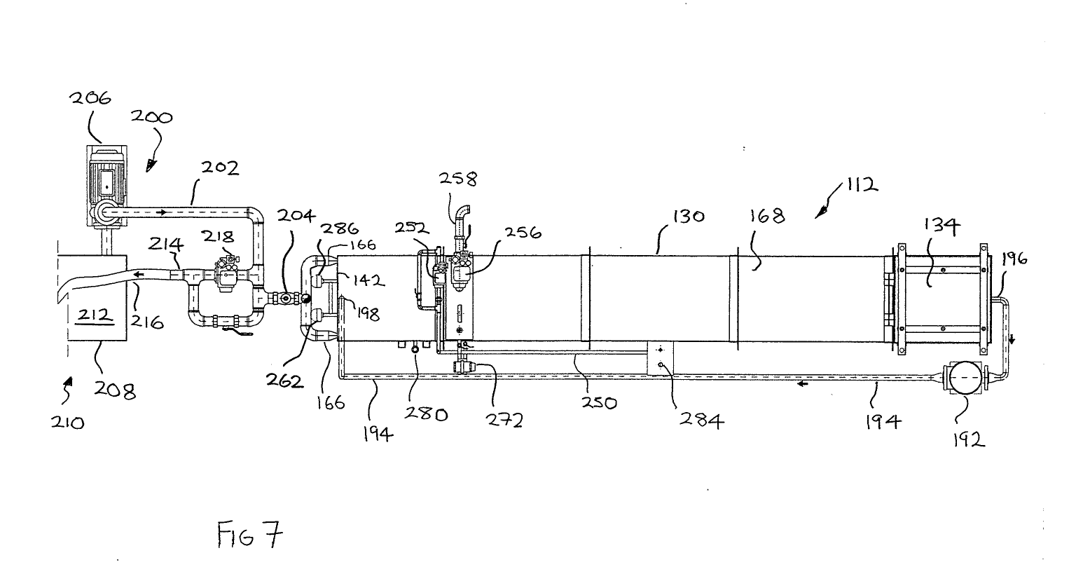

Referring to FIGS. 6 and 7, the seafood processing apparatus 110 may comprise a liquid circulation system 190 to move, or agitate, the water 118 within the tank 130. The agitation of the water is to promote a more even temperature in the water and at least partially prevent the formation of cold spots in locations disposed remote from the steam distribution piping 172. The liquid circulation system 190 may comprise a recirculation pump 192 and water recirculation piping 194. The water recirculation piping 194 may have an inlet end 196 disposed towards the bottom of the tank 130 at the end at which the access opening 132 is located and an outlet end 198 that may enter the tank through a top panel 168 of the tank adjacent the end 142. In use, the recirculation pump 192 draws water from the tank 130 into the inlet end 196 of the recirculation piping 194 and pumps it through the recirculation piping to the outlet end 198. The water is discharged from the outlet end 198 back into the tank 130.

Referring to FIGS. 6 to 8, the seafood processing system 110 may comprise a cooling system 200 to supply a cooling liquid to the processing chamber 112. The cooling liquid is used to cool the sealed packages 114 once the pasteurizing process is complete. In the illustrated example, the cooling liquid is water and for convenience in the detailed description that follows references to the cooling liquid and components of the cooling system will be to water and cooling water. It is to be understood that such references to water are not to be taken as limiting. The cooling system 200 may comprise a cooling water inlet pipe 202 that connects with the water distribution piping 166 of the liquid supply system 160 via a check valve 204. A cooling water pump 206 may be connected with the cooling water inlet pipe 202 to pump cooling water to the processing chamber 112. In the illustrated example, the cooling water pump draws cooling water from a cooling water tank 208 (FIG. 7) that is a component of a separate cooling system 210. The cooling water tank 208 is not pressurized and holds iced water 212.

The cooling system 200 may also comprise a cooling water return pipe 214, which branches from the water inlet pipe 202 to return cooling water to the cooling water tank 208. The cooling water return pipe 214 may be connected with flexible piping 216 (FIG. 7) to complete the return line to the cooling water tank 208. The flexible piping 216 may be reinforced plastics piping. A regulating valve 218 may be provided in the cooling water return pipe 214. The regulating valve 218 may be an electrically controlled regulating valve actuable by an electrical input. The regulating valve 218 may be actuable to control the pressure of the cooling water in the cooling water inlet pipe 202 and the check valve 204 may be configured and arranged to open only when the pressure of the cooling water in the cooling water inlet pipe 202 is at least equal to the pressure P1 in the pressurized processing chamber 112. This ensures that the pressurized air is at least substantially prevented from escaping from the processing chamber 112 via the check valve 204 during a cooling process in which cooling water is pumped into the processing chamber via the water distribution piping 166.

Referring to FIGS. 6 to 8, the tank 130 may be provided with a discharge pipe 230 and a discharge pipe valve 232. The discharge pipe valve 232 may be actuable to open and close the discharge pipe 230. The discharge pipe valve 232 may be actuated to allow the discharge of the heated water 118 or the cooling water from the tank 130. In order to reduce energy wastage, the discharge pipe 230 may be connected so as to discharge the heated or cooled water to locations at which either may be utilized for further processes. For this purpose, the discharge pipe 230 may be connected with a suitable pump (not shown). Alternatively, the discharge pipe 230 may discharge into a drain system. The tank 130 may be provided with a second discharge pipe 234. The second discharge pipe 234 may be connected with a manually operated valve 236. The second discharge pipe 234 allows the tank 130 to be emptied manually in the event of failure of the discharge pipe valve 232, or at least independently of electrical control. The second discharge pipe 234 is also configured to allow more complete drainage of the water 118 from the tank 130.

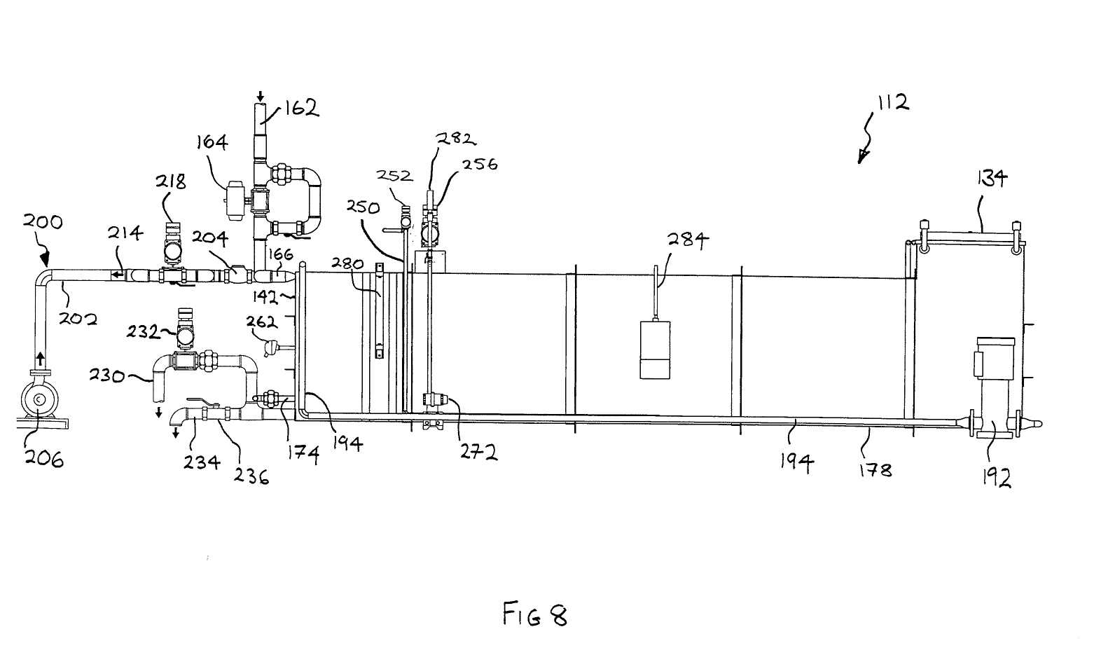

Referring to FIGS. 6 and 8, the gas supply system 120 may supply pressurized gas to the processing chamber 112 in the form of compressed air. For convenience, in the detailed description that follows reference will be made to the supply of compressed air. However this is not to be taken limiting as other gases, including mixtures that may include air, may be used. The gas supply system 120 may comprise a gas inlet pipe 250 and a gas inlet valve 252 disposed upstream of the tank 130. The gas inlet valve 252 may be an electrically controllable valve actuable to control the flow of pressurized air into the tank 130. The pressurized air may be supplied by a compressor or from a centralized compressed air system that provides compressed air to various locations in a factory or the like. In the illustrated example, the pressurized air is provided by a compressor 254, which may be a 7.5 kW compressor. The compressor 254 may be provided with an integral reservoir and a pressure switch so that the compressor can operate automatically to maintain a desired output pressure range. The gas outlet valve 256 may be an electrically controllable valve, such as an electrically controllable regulating valve, actuable to allow air 124 to be released from the processing chamber 112 via the gas outlet pipe 258 to reduce the gas pressure in the chamber.

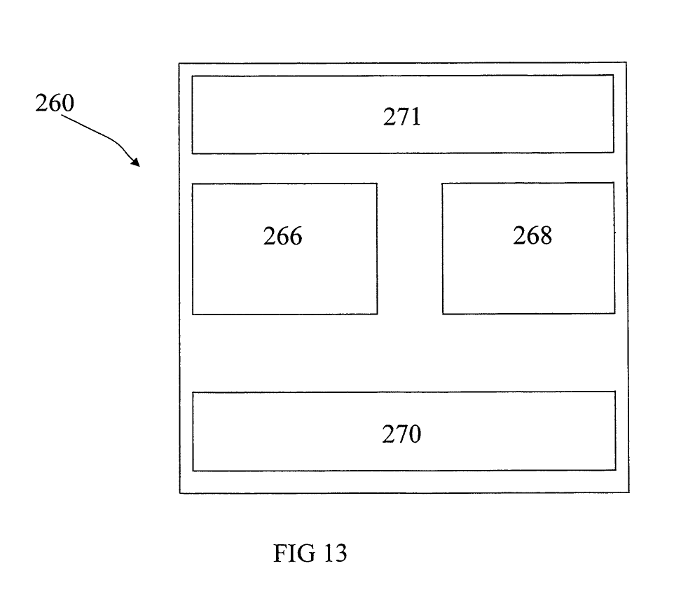

Referring to FIGS. 6, 7 and 13, the control system 122 may comprise a controller 260 and at least one sensor 262, 264 connected with the controller to provide signals utilized by the controller in controlling the pressure P1 of the compressed gas 124 in the processing chamber 112. As described in more detail below, the controller 260 may additionally control other functions of the seafood processing apparatus 110 to provide for complete, or at least substantially complete, automation of the processing of the sealed packages 114. The controller 260 may be a dedicated piece of hardware built to operate the seafood processing apparatus 110 or a general purpose controller set up, or arranged, to operate in the seafood processing apparatus. The controller 260 may be a general purpose programmable logic controller (PLC) that has been set up to operate the seafood processing apparatus 110. The controller 260 may comprise one or more processors 266, memory 268, one or more interface modules 270 and one or more input/output modules. The controller 260 may be provided with software or firmware that enables it to be programmed to carry out control functions. The memory 268 may comprise permanent memory and volatile memory and store commands forming a sequence by which a process is controlled. The interface module(s) 270 may be configured to allow external devices to be connected with the controller so that the controller can receive input signals from external devices and send output signals, including commands, to such devices. The input/output module(s) 271 may comprise a keypad, buttons, switches, touch screens and the like configured to permit operators to input commands, program instructions, data and the like. The input/output module(s) 271 may comprise ports, for example USB ports, that allow the input of data, commands, programming instructions electronically.

Referring to FIGS. 6 and 9, the sensor 262 may take the form of a temperature sensor that is arranged to sense the temperature of the water 118 in the tank 130. Since the internal pressure P2 in the sealed packages 114 is directly proportional to temperature, signals from the temperature sensor 262 provide an indication of the pressure P2. Although not essential, the temperature sensor 262 may take the form of a thermocouple. The sensor 264 may be a pressure sensor and is arranged to be exposed to the compressed air 124 and output signals indicative of the air pressure. The sensor 264 may, for example, be a peizo resistive pressure sensor, strain gauge using, for example a Wheatstone bridge, or a variable capacitance pressure sensor.

Referring to FIGS. 6 to 8, the control system 112 to may further comprise a liquid level sensor 272 connected with the controller 260 to provide signals indicative of the level of the water 118 in the tank 130. The controller 260 is configured to control filling of the tank 130 and operation of the liquid circulation system 190 using signals received from the liquid level sensor 272.

The processing chamber at 112 is provided with a pressure release valve (not shown) configured to vent air 114 from the processing chamber 112 if the pressure P1 exceeds a predetermined pressure PMAX.

Referring to FIGS. 6 to 8, the processing chamber 112 may be provided with devices to allow the operator to view the operating functions of the seafood processing apparatus 110 independently of any display that may be provided on the controller 260. For example, a liquid level gauge 280 may be fitted to the tank 130 to allow an operator to see the level of the water 118 in the tank. A pressure gauge 282 may be provided to permit an operator to see the pressure P1 of the air 124 in the processing chamber 112. A temperature sensor 284, such as a thermometer, may be provided to allow an operator to see the temperature of the water 118 in the tank 130.

As shown in FIGS. 6 and 7, a further temperature sensor 286 may be provided to output signals indicative of the temperature of the water 118 in the tank 130. The temperature sensor 286 may, for example, be a thermocouple immersed in the water 118. The temperature sensor 286 is not used in controlling the operation of the seafood processing apparatus 110. Instead, the temperature sensor 286 is used in maintaining a record of the temperature of the water 118 to form a part of the process records that may have to be kept for food regulatory purposes.

In use of the seafood processing apparatus 110, an operator loads sealed packages 114 containing seafood into the processing chamber 112. The packages 114 may be loaded into the processing chamber 112 in one or more of the baskets 138. The baskets 138 may be positioned on the guide rails 136 so that they are supported by the rails and can be moved along the processing chamber 112 guided by the rails. Once the processing chamber 112 is loaded with the desired number of packages 114, the operator seals the access opening 132 by means of the cover 134 and inputs a start command to the controller 260. The controller 260 may initiate operation of the seafood processing apparatus 110 by sending a signal to the water inlet valve 164 to cause the valve to open and allow water to flow through the water inlet pipe 162 into the water distribution piping 166. The water is conveyed into the processing chamber 112 by the water distribution piping 166 where it is output into the tank 130.

The liquid level sensor 272 outputs signals to the controller 260 indicating the level of the water 118 in the tank 130. When the signals indicate that a predetermined level has been reached, the controller 260 sends a signal to the recirculation pump 192 to start up. The predetermined level may be approximately 50% of the tank height, for example 52%. The recirculation pump 192 then operates to draw water from the tank 130 and pump it through the re-circulation piping 194 and back into the tank to create a recirculating flow of the water, thereby agitating the water in the tank. When the controller 260 receives signals from the liquid sensor 272 indicating that a predetermined fill level has been reached, a signal is sent to the water inlet valve 164 to cause it close and prevent the flow of water through the water inlet pipe 162. The fill level may be around 90% of the tank height, for example 92%.

When the tank 130 is filled to the required fill level, the controller 260 activates the heating system 116 by sending a signal to the steam inlet valve 182. The signal causes the steam inlet valve 182 to open and allow steam to flow through the steam supply piping 174 into the steam distribution piping 172. Heat from the steam distribution piping 172 is output into the water 118 progressively heating the water to raise its temperature to the pasteurization temperature. The pasteurization temperature may be around 85 to 95° C. The controller 260 is able to monitor the temperature of the water 118 utilizing signals received from the temperature sensor 262 and cause the steam inlet valve 182 to open and close in such a way as to bring the temperature of the water up to the pasteurization temperature as quickly as possible and then maintain the pasteurization temperature during the pasteurization (cooking) process. This may involve causing the steam inlet valve 182 to remain continuously open while the temperature of the water 118 is raised to the pasteurization temperature and then causing the valve to close once the required temperature is reached. Since the processing chamber 112 is closed and sealed, the temperature in the chamber should remain relatively steady and not fluctuate, even though the supply of steam is halted. If the temperature of the water 118 as sensed by the temperature sensor 262 approaches or falls below a predetermined lower limit, for example 85° C., the controller 260 may send a signal to the steam inlet valve 182 to cause it to open and admit more steam into the processing chamber 112.

While steam is being admitted into the processing chamber to raise the temperature of the water at 118, the controller 260 sends a signal to the gas inlet valve 252 to cause the valve to open and admit pressurized air into the processing chamber 112 to provide a controlled pressure P1 volume of air 124 in the processing chamber. If the pressurized air is supplied by a compressor 254 associated with the seafood processing apparatus 110, rather than a centralized compressed air supply system, it may be necessary for the controller 260, or an operator, to start the compressor earlier so as to allow a build-up of air pressure prior to the issue of the signal by the controller to the gas inlet valve 252.

The controller 260 may be configured to provide signals that cause the pressure P1 of the air 124 to be controlled such that the internal pressure P2 in the sealed packages 114 is at least one of:

not greater than the pressure P1 by more than a predetermined amount;

equal to the pressure P1; and

less than said pressure P1.

The controller 260 may control the pressure P1 utilizing:
i) signals from the temperature sensor 262 and pressure sensor 264 and pressure P1 against temperature relationship data stored in a lookup table in the memory 268;
ii) signals from the pressure sensor 264 and pressure P1 against time relationship data stored in a lookup table in the memory 268; or
iii) a combination of the methods referred to in i) and ii).

The internal pressure P2 in the sealed packages 114 should be proportional to the temperature of the water 118 as sensed by the temperature sensor 262. This knowledge can be used to develop relationship data for the lookup tables based on measurements of the pressure P2 and corresponding water temperature obtained during trials using the seafood processing apparatus 110 or a suitable apparatus arranged for conducting trials to obtain suitable data. The pressure P2 data may be obtained using a mini, wireless, pressure sensor placed in a sealed package containing seafood during trials. The data obtained can be tabulated in combination with a pressure P1 that is selected to provide the desired pressure P2 against pressure P1 relationship as shown, for example, in the tables below.

TABLE I
Pressure P1 - Time Relationship

| Time (T) | Sensed Pressure P2 | Pressure P1 | |
|---|---|---|---|
| 0 | y | z | |
| 1 | x + 1 | z + 1 | |
| 2 | y + 2 | z + 2 | |
| . . . | . . . | . . . | . . . |
| . . . | . . . | . . . | . . . |
| 10 | y + 10 | z + 10 | |
| 11 | y + 10 | z + 10 | |
| 12 | y + 10 | z + 10 | |
| 13 | y + 9 | z + 9 | |
| . . . | . . . | . . . | . . . |
| 15 | y + 1 | z + 1 | |

TABLE II
Pressure P1 - Temperature Relationship

| Sensed Temperature (t) | | Sensed Pressure P2 | | Pressure P1 |
|---|---|---|---|---|
| x | | y | | z |
| x + 1 | | x + 1 | | z + 1 |
| x + 2 | | y + 2 | | z + 2 |
| . . . | . | . . . | . | . . . |
| . . . | | . . . | | . . . |
| x + 10 | | y + 10 | | z + 10 |
| x + 10 | | y + 10 | | z + 10 |
| x + 10 | | y + 10 | | z + 10 |
| x + 9 | | y + 9 | | z + 9 |
| . . . | | . . . | | . . . |
| x + 1 | | y + 1 | | z + 1 |

A lookup table enabling control based on the pressure P1 against time relationship need only contain the time (T) and pressure P1 data. A lookup table enabling control based on the P1 against temperature relationship need only contain the sensed temperature (t) and pressure P1 data.

If the controller 260 is configured to control the pressure P1 based on the pressure P1 against time relationship, at each time interval, corresponding to the time intervals (T) used in obtaining the data for the lookup tables, the controller 260 compares the sensed pressure P1 as indicated by signals received from the pressure sensor 264 against the respective value for the desired pressure P1 stored in the lookup table. If the pressure P1 indicated by the signals received from the pressure sensor 264 is not sufficiently high for that time interval, the controller 260 sends a signal to the gas inlet valve 252 to cause the valve to open and admit compressed air into the processing chamber 112 to raise the pressure P1 of the air 124. If the pressure is greater than the required pressure P1 indicated in the lookup table by a predetermined amount, the controller 260 may send a signal to the gas outlet valve 256 to cause the valve to open and release air 124 from the processing chamber 112 to reduce the air pressure.

If the controller 260 is configured to control the pressure P1 based on the pressure P1 against temperature relationship, the controller periodically determines what the pressure P1 should be by matching the temperature of the water 118 as indicated by signals received from the temperature sensor 262 with the temperature values stored in the lookup table. The pressure P1 value indicated in the lookup table can then be compared with the actual pressure P1 indicated by signals received from the pressure sensor 264. If the pressure P1 indicated by the signals received from the pressure sensor 264 is not sufficiently high for that sensed temperature, the controller 260 may send a signal to the gas inlet valve 252 to cause the valve to open and admit compressed air into the processing chamber 112 to raise the pressure P1 of the air 124. If the pressure is greater than the required pressure P1 indicated in the lookup table by a predetermined amount, the controller 260 may send a signal to the gas outlet valve 256 to cause the valve to open and release air 124 from the processing chamber 112 to reduce the air pressure.

In the illustrated example, the controller 260 is configured to control the pressure P1 based on both a pressure P1 against temperature relationship and a pressure P1 against time relationship. During a phase of operation of the seafood processing apparatus 110 in which the heating system 116 is operating to raise the temperature of the water 118 in the processing chamber 112 to the pasteurization temperature, the controller 260 may control the pressure P1 based on a pressure P1 against temperature relationship. Once the pasteurization temperature has been reached and is being maintained during pasteurization of the seafood in the sealed packages 114, the control of the pressure P1 may be based on the pressure P1 against time relationship.

The controller processor 266 may set a pasteurization process commenced flag when signals from the temperature sensor 262 to indicate that the water temperature has reached the pasteurization temperature. The processor 266 may then use its internal clock, or another counter associated with the controller 260, to measure a set time period required for the pasteurization (cooking) phase to complete. When the processor 266 determines that the pasteurization phase is complete, the controller 260 may send signals to the discharge pipe valve 232 to cause the valve to open and allow the heated water 118 to discharge from the tank 130 via the discharge pipe 230. When the controller 260 receives signals from the liquid level sensor 272 indicating that a predetermined low water level has been reached, the controller signals the cooling system 200 to activate the cooling water pump 206 and the regulating valve 218. The cooling water pump 206 pumps cooling (iced) water from the cooling water tank 208 into the cooling water inlet pipe 202. Initially, the regulating valve 218 is fully open and the pressure in the cooling water inlet pipe 202 is insufficient to open the check valve 204. Consequently, the pumped cooling water is returned to the cooling water tank 208 via the cooling water return pipe 214 and flexible piping 216. As the regulating valve 218 is progressively closed, the pressure in the cooling water inlet pipe 202 builds up until there is sufficient pressure to open the check valve 204. Cooling water then flows through the check valve 204 into the water distribution piping 166 which discharges the cooling water into the tank 130.

The controller 260 may signal the discharge pipe valve 232 to close at substantially the same time as it signals the cooling system 200 to activate the cooling water pump 206 and regulating valve 218. Alternatively, the discharge pipe valve 232 may be kept open for a predetermined period following the activation of the cooling water system 200 to allow some residual heat to be removed from the processing chamber 112 in a flow of discharging cooling water. When the controller 260 signals the discharge pipe valve 232 to close, the tank 130 fills with cooling water. The rising water level is monitored by the controller 260 using signals received from the water level sensor 272. When a predetermined fill level is reached, the controller 260 signals the cooling water pump 206 to cease pumping. The predetermined fill level may be around 90% of the tank height, for example 92%. Either when a predetermined level is reached during the filling process, or when the fill process is complete and the cooling water pump 206 is commanded to cease pumping, the controller 260 may signal the recirculation pump 192 to commence pumping so that cooling water from the tank 130 is pumped through the recirculation piping 194. The recirculation pump 192 then operates to draw cooling water from the tank 130 and pump it through the recirculation piping 194 and back into the tank to create a recirculating flow of the water thereby agitating the cooling water in the tank. If the recirculation pump 192 is activated at a predetermined level, the level may be approximately 50% of the tank height, for example 52%.

During the discharge of heated water 118 from the tank 130, the pressure P1 in the processing chamber 112 would ordinarily start to reduce as the air 124 expands to occupy the volume previously occupied by the water. However, the internal pressure P2 in the sealed packages 114 may remain high due to the high temperature within the packages. In order to maintain the desired pressure relationship between the internal pressure P2 and pressure P1, the controller 260 may send signals to the gas inlet valve 252 to open and allow more compressed air to flow into the processing chamber 112. The controller 260 may be configured to use the pressure P1 against time relationship or pressure P1 against temperature relationship as described above to control the opening of the gas inlet valve 252 to maintain the desired pressure relationship. Once the cooling process commences and the sealed packages 114 are exposed to the cooling water, the internal pressure P2 should reduce as the temperature of the packages and their contents falls. As the internal pressure P2 reduces, the controller 260 may operate to control the pressure P1 so that it is also reduced so as to maintain a desired relationship between the internal pressure P2 and the pressure P1. To reduce the pressure P1 the controller 260 sends signals to the gas outlet valve 256 to cause it to open and allow air 124 to vent from the tank 130. The controller 260 may be configured to use the pressure P1 against time relationship or pressure P1 against temperature relationship as described above to control the opening of the gas outlet valve 256 to maintain the desired pressure relationship. In the illustrated example, the controller 260 is configured to use the pressure P1 against time relationship to control the opening and closing of the gas inlet and outlet valves 252, 256 during the emptying of the heated water 118 from the tank and during cooling process.

When signals from the pressure sensor 264 indicate that the pressure in the tank 130 has fallen to atmospheric pressure, the controller 260 deems cooling process complete. The cooling process may take between six and twenty minutes. When the controller 260 has determined that the cooling process is complete, it may send a signal to the recirculation pump 192 to cease pumping and command the discharge pipe valve 232 to open and allow discharge of the cooling water from the tank 130. The cover 134 may then be opened and the baskets 138 containing the sealed packages 114 transferred from the processing chamber 112 to the cooling water tank 208, which may contain iced water. At this stage the seafood in the sealed packages 114 will still be warm. The packages 114 are left in the cooling water tank 208 to completely cool prior to the transfer of the packages to a refrigerated environment. In the meantime, the seafood processing apparatus 110 can be prepared for another pasteurization process by loading further baskets 138 containing sealed packages 114 into the tank 130.

The seafood processing apparatus 110 is configured so that a predetermined relationship can be maintained between the internal pressure P2 in the sealed packages and the pressure P1 of the gas in the processing chamber 112. In some examples the relationship is maintained such that the internal pressure P2 does not exceed the pressure P1 by more than a predetermined amount or is substantially equal to the pressure P1. In currently preferred examples, the pressure P1 is maintained so that it is above the internal pressure P2. The pressurization of the processing chamber with the gas may prevent stressing of the seals, or seams, of the sealed packages. In an unpressurised processing chamber, there would be insufficient resistance to the build up of pressure in the sealed packages to prevent stressing of the seals, or seams, of the package, potentially leading to a breach of the package. For example, in the case of a sealed package as illustrated by FIGS. 1 to 4, the seal between the closure member and metal body may be made by a relatively weak peel adhesive intended to allow easy opening of the package and the build up of pressure within the package may be sufficient to break the adhesive seal, letting liquid from the processing chamber into the package thereby spoiling the seafood contained in the package. The application of the seafood processing apparatus is not limited to sealed packages as illustrated by FIGS. 1 to 4. The benefits of not stressing the seals, or seams, of sealed packages containing seafood may be equally applicable to, for example, packages comprising plastics pouches or plastics tubs with easy open metal lids.

In the illustrated example, the rails for the baskets are disposed in an upper region of the processing chamber such that the baskets are suspended from the rails and hang down into the water 118. This is not essential. In some examples a single rail may be provided and the baskets configured to engage and run on a single rail. In other examples, rails may be provided in a lower region of the processing chamber, including along the bottom of the processing chamber.

It is to be understood that complete cooling of the sealed packages may take place in the processing chamber prior to transferring the cooled packages to a refrigerated environment, such as a refrigerated store or refrigerated transportation container. In examples in which complete cooling takes place in the processing chamber, a separate cooling chamber, such as the cooling tank 208, may be unnecessary. However, it may be advantageous to have a first stage cooling process take place in the processing chamber to partially cool the packages followed by a second stage cooling process in a separate cooling chamber to complete the cooling of the packages. By reducing the time the packages spend in the processing chamber, it is possible to increase the throughput of the seafood processing apparatus. In examples in which the packages are only partially cooled in the processing chamber, the cooling should be such as to reduce the internal pressure P2 in the packages to atmospheric pressure.

In the illustrated example, a thermocouple is used to provide indications of water temperature that are used to indicate pressure. It is to be understood that this is not essential. For example, other types of temperature sensor such as thermistors or infra red temperature sensors may be used. Alternatively, pressure sensors or a combination of pressure sensors and temperature sensors may be used. Since suitable pressure and temperature sensors will be known to persons skilled in the art, an exhaustive list of such is not provided herein.

In the illustrated example, the processing chamber is configured to receive a plurality of containers that can each contain a plurality of sealed packages containing seafood. It is to be understood that this is not essential. A seafood processing apparatus according to the invention may be configured to hold just one container containing such packages.

The invention includes methods of processing seafood and seafood processing apparatus in which sealed packages containing seafood are submerged in a liquid in a processing chamber during a cooking process and the pressure of a volume of gas in the processing chamber is controlled such that as the internal pressure in the packages varies due to changes of temperature in the processing chamber the resultant forces acting on the seals, or seams, of the packages will at least not exceed a predetermined value. The pressure of the gas may be controlled such that the internal pressure does not exceed the gas pressure by more than a predetermined amount. The pressure of the gas may be controlled such that the internal pressure and gas pressure are substantially equal and there is substantially no net force acting to separate the seals or seams. The pressure of the gas may be controlled such that the internal pressure is lower than the gas pressure. In some examples, the gas pressure may be controlled such that during certain phases of a cooking process in which the internal pressure is relatively low, the gas pressure is not more than a predetermined amount less than the internal pressure and during increased temperature phases during which the internal pressure is relatively high, the gas pressure is greater than the internal pressure.

In some examples in which the gas pressure is maintained above the internal pressure, it may be desirable to ensure that the gas pressure is not too much greater than the internal pressure, either to avoid damage to the package contents or damage to a seal or seam of the package. For example, in the case of a sealed package such as that illustrated by FIGS. 1 to 4, if the gas pressure were allowed to exceed the internal pressure by too great an amount, the closure member may flex (dip in the center) thereby stressing the seal between the closure member and the metal body and potentially causing the periphery of the closure member to lift away from the metal body and break the seal.

Control of the gas pressure based on a predetermined P1 against time relationship may require that the desired pressure P1 is set higher than the internal pressure in the sealed packages to provide a factor of safety in case the process conditions vary too greatly from the test conditions under which the data representing the relationship was obtained. Control based on data representing a pressure P1 against temperature relationship may facilitate more accurate control requiring a lesser, or no safety factor.

It is to be understood that the illustrated and described examples are given to aid understanding of the invention and changes and modifications to the specifically-described examples may be carried out without departing from the principles of the present invention, which is intended to be limited only by the scope of the appended claims, as interpreted according to the principles of patent law, including the doctrine of equivalents.

Thus, although there have been described particular embodiments of the present invention of a new and useful SEAFOOD PROCESSING APPARATUS AND METHODS OF PROCESSING SEAFOOD it is not intended that such references be construed as limitations upon the scope of this invention except as set forth in the following claims.

What is claimed is:

1. A method of processing seafood comprising:
disposing a sealed package containing seafood in a seafood processing chamber;
providing a liquid in said processing chamber in which liquid said package is submerged;
heating said liquid to a pasteurization temperature to pasteurize said seafood;
providing a controlled pressure gas in said processing chamber; and
controlling the pressure P1 of said controlled pressure gas such that during pasteurization of the seafood an internal pressure P2 in said package is at least one of:
not greater than said pressure P1 by more than a predetermined amount;
equal to said pressure P1; and
less than said pressure P1.

2. A method of processing seafood as claimed in claim 1, further comprising providing a cooling fluid in said heating chamber to cool said package after pasteurization of said seafood and during cooling of said package controlling the pressure P1 of said controlled pressure gas such that during pasteurization of the seafood an internal pressure P2 in said package is at least one of:
not greater than said pressure P1 by more than a predetermined amount;
equal to said pressure P1; and
less than said pressure P1.

3. A method of processing seafood as claimed in claim 2, wherein said cooling fluid is admitted to said processing chamber via a one-way valve and providing said cooling fluid comprises flowing said cooling fluid through a valve having a variable size valve opening and controlling the size of said opening to increase the pressure of the cooling fluid whereby said cooling fluid opens flows through said one-way valve when the size of said opening is such that the pressure of the cooling fluid is increased to at least the pressure P1 in said processing chamber.

4. A method of processing seafood as claimed in claim 2, wherein said cooling of said sealed package comprises a first stage of a cooling process and subsequent to said first stage, said package is transferred to a cooling chamber for a second stage cooling process.

5. A method of processing seafood as claimed in claim 1, wherein said pressure P1 is controlled in accordance with at least one of:
i) a predetermined pressure P1 against time relationship; and
ii) a predetermined pressure P1 against temperature of said liquid relationship.

6. A method of processing seafood as claimed in claim 5, wherein during heating of said liquid to said pasteurization temperature said pressure P1 is controlled in accordance with said predetermined pressure P1 against temperature relationship.

7. A method of processing seafood as claimed in claim 5, wherein controlling said pressure P1 in accordance with said predetermined pressure P1 against temperature relationship comprises comparing a sensed temperature of said liquid and a sensed pressure P1 with a value for P1 stored in an electronic memory.

8. A method of processing seafood as claimed in claim 5, wherein after heating of said liquid to said pasteurization temperature, at least while said liquid is substantially at said pasteurization temperature said pressure P1 is controlled in accordance with said predetermined pressure P1 against time relationship.

9. A method of processing seafood as claimed in claim 5, wherein controlling said pressure P1 in accordance with said predetermined pressure P1 against time relationship comprises sensing said pressure P1 at a predetermined time and comparing the sensed pressure P1 with a desired value for P1 for that time that is stored in an electronic memory.

10. A method of processing seafood as claimed in claim 1, wherein said gas comprises compressed air.

11. A method of processing seafood as claimed in claim 1, wherein said processing chamber is connected with gas inlet valving and gas outlet valving and controlling said pressure P1 comprises selectively opening said inlet valving to admit pressurized gas into said processing chamber and selectively opening said outlet valving to release pressurized gas from said chamber.

12. A method of processing seafood as claimed in claim 1, wherein heating said liquid comprises introducing steam into said processing chamber.

13. A method of processing seafood as claimed in claim 1, further comprising drawing said liquid from said processing chamber via an opening provided at a first position and pumping said liquid back into said processing chamber via a second opening provided at a second position that is spaced from said first position to promote circulation of said liquid in said processing chamber.

14. A method of processing seafood as claimed in claim 1, wherein said sealed package comprises a metal body having an opening to permit access to said seafood and a closure member that releasably sealingly closes said opening, said closure member comprising at least a portion configured to permit viewing of said seafood through the closure member.

15. A method of processing seafood as claimed in claim 14, wherein said closure member is releasably sealingly secured to said metal body by adhesion.

16. A method of processing seafood as claimed in claim 15, wherein said adhesion is provided by a polymer peel layer.

17. A method of processing seafood as claimed in claim 1, wherein said seafood is crabmeat.

18. A method of processing seafood as claimed in claim 1, further comprising disposing said seafood package in a package container with a plurality of other sealed packages containing seafood and disposing said sealed package in said processing chamber comprises loading said package container into said processing chamber and moving said package container along a guide track provided in said processing chamber.

19. Seafood processing apparatus comprising:
a seafood processing chamber to receive a liquid in which sealed packages containing seafood are to be submerged;
a heating system to deliver heat to said liquid in said processing chamber to heat said liquid to a pasteurization temperature to pasteurize the seafood in said sealed packages;
a gas supply system to supply pressurized gas to said processing chamber; and
a control system configured to control the pressure P1 of the pressurized gas in said processing chamber such that during pasteurization of the seafood an internal pressure P2 in said seafood package is at least one of:
not greater than said pressure P1 by more than a predetermined amount;
equal to said pressure P1; and
less than said pressure P1.

20. Seafood processing apparatus as claimed in claim 19, further comprising a cooling system to deliver a cooling liquid into said processing chamber to cool said sealed packages after pasteurization of said seafood.

21. Seafood processing apparatus as claimed in claim 20, wherein said cooling system comprises a one-way valve and a regulating valve and said control system is configured to close said regulating valve to raise the pressure of the said cooling fluid flowing therethrough whereby said one-way valve opens to admit the cooling fluid into said processing chamber when the pressure of the cooling fluid is raised to at least the pressure P1 of said controlled pressure gas in the processing chamber.

22. Seafood processing apparatus as claimed in claim 19, wherein said control system is configured to control said pressure P1 in accordance with at least one of:
i) a predetermined pressure P1 against time relationship; and
ii) a predetermined pressure P1 against temperature of said liquid relationship.

23. Seafood processing apparatus as claimed in claim 22, wherein said control system is configured to control said pressure P1 in accordance with said predetermined pressure P1 against temperature of said liquid relationship when said control system is causing said heating system to heat said liquid to said pasteurization temperature.

24. Seafood processing apparatus as claimed in claim 22, wherein said control system is configured to control said pressure P1 in accordance with said predetermined pressure P1 against time relationship when said control system determines that said liquid has been heated to said pasteurization temperature at least while said liquid is substantially at said pasteurization temperature.

25. Seafood processing apparatus as claimed in claim 22, wherein said control system comprises a memory and data representing at least one of:
i) said predetermined pressure P1 against time relationship; and
ii) said predetermined pressure P1 against temperature of said liquid relationship is stored in said memory.

26. Seafood processing apparatus as claimed in claim 25, wherein said control system comprises a temperature sensor arranged to sense the temperature of said liquid in said processing chamber and a pressure sensor arranged to sense the pressure P1 of said pressurized gas in said processing chamber and controlling said pressure P1 in accordance with said predetermined pressure P1 against temperature relationship comprises comparing a temperature of said liquid sensed by said temperature sensor and a sensed pressure P1 sensed by said pressure sensor with a desired value for P1 stored in said electronic memory.

27. Seafood processing apparatus as claimed in claim 25, wherein said control system comprises a pressure sensor arranged to sense the pressure P1 of said pressurized gas in said processing chamber and controlling said pressure P1 in accordance with said predetermined pressure P1 against time relationship comprises comparing a pressure P1 sensed by said pressure sensor at a predetermined time with a desired value for P1 for that time that is stored in said electronic memory.

28. Seafood processing apparatus as claimed in claim 19, wherein said heating system comprises a steam distribution body disposed in said processing chamber to output heat into said liquid.

29. Seafood processing apparatus as claimed in claim 19, further comprising a package container to contain a plurality of said sealed packages and an elongate container support provided in said processing chamber, said container support defining a guide track and being arranged so that the container can be moved along said processing chamber guided and supported by said guide track.

30. Seafood processing apparatus as claimed in claim 29, wherein said elongate container support comprises a first elongate rail and a second elongate rail disposed parallel and spaced from said first elongate rail and said container is provided with respective rolling members engagable with said first and second rails.

31. Seafood processing apparatus as claimed in claim 29, wherein said container and elongate container support are configured such that said container hangs from said container support.

32. Seafood processing apparatus as claimed in claim 19, further comprising a liquid recirculation system operable to draw said liquid from said processing chamber through a first opening provided in said processing chamber and pump said liquid back into processing chamber via a second opening that is provided in said processing chamber at a location spaced apart from said first opening.

33. Seafood processing apparatus as claimed in claim 32, wherein said first and second openings are spaced apart in a lengthways direction of said processing chamber and are at different heights.

34. Seafood processing apparatus as claimed in claim 19, wherein said gas supply system comprises valving and said control system is configured to actuate said valving to control said pressure P1 by selectively admitting pressurized gas into said processing chamber and releasing gas from said processing chamber.
